(19) United States
(12) Patent Application Publication
(10) Pub. No.: US 2024/0288130 A1
(43) Pub. Date: Aug. 29, 2024

(54) Transient Feature Recognition Technique for Defect Detection, Classification and Location Identification in Water Supply

(71) Applicant: The Hong Kong University of Science and Technology, Hong Kong (CN)

(72) Inventors: Moez LOUATI, Hong Kong (CN); Muhammad WAQAR, Al Khobar (SA); Mohamed Houcem Eddine BEN ARAB, Hong Kong (CN)

(21) Appl. No.: 18/585,161

(22) Filed: Feb. 23, 2024

Related U.S. Application Data
(60) Provisional application No. 63/487,012, filed on Feb. 26, 2023.

(51) Int. Cl. F17D 5/02; G01M 3/28

(52) U.S. Cl. CPC F17D 5/02; G01M 3/2815

(57) ABSTRACT

A technique for detection, classification and location identification of defects in a pressurized pipe network uses supervised machine learning and transient response signals (TRSs) of potential defect scenarios as training data. The TRSs are obtained from a model and/or measurements. The TRSs are arranged in an appropriate matrix form and its singular vectors (SVs) are obtained using singular value decomposition. The defect detection and classification procedure is conducted by projecting a measured TRS of the pipe network into a SV space. The location of the measured TRS in the SV space indicates the state of defective pipe section (if any), classify the defect according to clusters of training data (e.g., leak, blockage), and locate the defect within an identified defective section. The technique can accurately detect defective pipes in a network with a training data set as small as three scenarios per pipe section and one single measurement location.

### CROSS-REFERENCE TO RELATED APPLICATIONS

This application claims priority to, and the benefit of, U.S. Provisional Patent Application No. 63/487,012, filed on Feb. 26, 2023, the disclosure of which is hereby incorporated by reference in its entirety.

### LIST OF ABBREVIATIONS

2D two-dimensional
3D three-dimensional
ANN artificial neural network
CNN convolutional neural networks
DMA district metered area
DNN deep neural network
eigen-TR eigen-transient-response
FRF frequency response function
ITA inverse transient analysis
ML machine learning
MOC method of characteristics
NN neural network
NCA neighborhood component analysis
PRV pressure-reducing valve
SNR signal-to-noise ratio
SV singular vector
SVD singular value decomposition
TR transient response
TRS transient response signal

### TECHNICAL FIELD

The present disclosure relates to a supervised ML technique of determining a state of health of a pressurized pipe network to thereby detect, classify or locate a possible defect occurred in the pipe network.

### BACKGROUND

Pressurized conduits transporting fluids such as freshwater, seawater, stormwater, wastewater, oil, etc. often experience the formation of defects (e.g., leaks or blockages) during their lifetime due to physical and/or chemical processes. These defects result in tremendous wastage of energy and financial resources, reduction in carrying capacity, and an increased potential source of contamination. According to the World Bank estimate, the monetary value of lost water worldwide is about US$15 billion per year. The Asian Development Bank estimated that 29 billion cubic meters of fresh water, valued at US$9 billion, is lost in Asia every year. Investment in making water systems more efficient is an effective path to economic growth (Connor 2015).

Extensive effort has been spent on developing robust and accurate techniques for leak detection in pressurized (usually buried) pipe systems. Among various existing commercial methods, noise correlators are frequently used in practice. Such techniques passively measure noise generated from leaks and cross-correlate measurements to identify leak locations. However, these methods confront several challenges that make them vulnerable in practice. For instance, (i) leak noise usually does not propagate long enough, especially in plastic (HDPE pipes), (ii) equipment used for data collection are sensitive to different types of soil, (iii) the distance between two transducers needs to be short and within a single pipeline, (iv) leak noise is easily affected by external as well as environmental noise (e.g., traffic noise, construction work, etc.). Other commercial methods such as smart ball (Eng and Eng 2013) and Sahara system (Bond et al. 2004) are expensive, time-consuming, and labour intensive. In addition, these methods are mostly suitable for single pipes and cannot be used in a pipeline network composed of loops and branches of different diameters.

To avoid the challenges posed by passive leak detection techniques, transient-based techniques were introduced in the past three decades where an active transient response signal is used to diagnose and obtain information about the integrity of the pipe system. An “active” transient response means that a transient pressure wave is generated in the fluid by a pipeline operator from a desired location in the pipe network and with a desired waveform, then the response of the system to such wave is measured. Over the past 30 years, a variety of techniques have been introduced to extract defect information from the measured TRS such as (i) ITA (e.g., Liggett and Chen 1994; Kapelan et al. 2003; Covas et al. 2004; Vítkovský ct al. 2007; Capponi et al. 2017), (ii) transient damping-based methods (Wang et al. 2002; Nixon and Ghidaoui 2007; Brunone et al. 2018), (iii) transient-reflection-based methods (e.g. Brunone 1999; Ferrante et al. 2007), and (iv) frequency response-based methods (e.g. Mpesha et al. 2002; Lec et al. 2005; Covas et al. 2005; Sattar and Chaudhry 2008; Duan et al. 2012; Louati et al. 2020). However, most of these foregoing methods are tested on either single pipe systems or simple Y-branch systems under an assumption of known defect types (i.e., leak or blockage). Moreover, these methods are sensitive to noise and interference under small SNR conditions, and require precise knowledge of the pipe boundaries, hydraulic characteristics, and system topology. Recently, time-reversal methods have also been introduced which are based on the time-invariance property of the wave equation (Waqar et al. 2022). These methods are robust to noisy measurements and are applicable in both time and frequency domains (e.g., Wang and Ghidaoui (2018), Zouari et al. (2019), Waqar et al. (2019)). Thus far, time-reversal methods are only applied to simple test cases (mostly single pipelines or Y-system networks), and rely heavily on the no-leak baseline (namely, a transient response obtained in a no-leak case), which is often unavailable.

In recent years, several researchers have also focused on integrating ML techniques with TRS. Zhou et al. (2019) applied DNN algorithm and used the system's FRF (frequency response function) to detect a leak in a single pipeline. Bohorquez et al. (2020) pioneered the use of ANNs and CNNs for the localization of leaks and changes in pipe areas within a single pipeline. Their approach, notably utilizing the first half-period of TRS, laid the groundwork for further innovation. Building upon this, Bohorquez et al. (2022) introduced a stochastic resonance enhancement technique to augment the CNN-based detection method. This subsequent contribution, tested in a controlled laboratory environment, demonstrated a marked improvement in leak detection accuracy. The success of these methods in precise anomaly detection within water pipelines represents a significant advancement in the field, showcasing the potential of NN-based approaches in pipeline monitoring scenarios. However, these developments are also limited to simple pipe systems with known defect types and large SNRs. Such limitation was addressed by Liao et al. (2021) by considering a DMA size network and applying deep learning algorithms to detect leaks in a network using the FRF of the system. However, their study is limited to cases where the defect type is already known. Furthermore, a fundamental limitation of NN-based methodologies is their inherent constraint in generalizing beyond the scope of their training dataset. This issue is exacerbated by their sensitivity to hyperparameters, such as the number of neurons, the architecture and depth of hidden layers, and the interconnections between them (Rumelhart et al., 1994). To mitigate this, it is imperative to utilize extensive training datasets that encapsulate a broad spectrum of potential scenarios. This approach facilitates the robust training of NN models. Additionally, the process necessitates careful tuning of hyperparameters through iterative optimization to achieve optimal performance (Beucler et al., 2021). Recently, Ayati et al. (2022) introduced a novel hybrid approach combining ML with hydraulic transient modeling. This method uses NCA for transient features selection and utilizes different classifiers to estimate the leak's size and location. It was validated experimentally for a single pipe and tested synthetically for a complex water distribution network. While their technique requires a smaller training data set compared to NN, the amount of required training dataset would grow as the system becomes more complex. More recently, Asghari et al. (2023) introduced a novel framework for leak detection that leverages transient waves, marking a paradigm shift away from traditional metaheuristic optimization algorithms. This innovative approach utilizes an ensemble of CatBoost models, focusing on classifying leaky sections and predicting leak sizes. The study's reported high levels of accuracy and F1 scores not only attest to the efficacy of ML models in transient-based leak detection but also pave the way for advanced, more precise detection methods in the intricately woven fabric of complex pipe networks.

There is a need in the art for an improved ML technique that uses TRS's for defect detection in a pressurized pipe network and that overcomes at least some of the above-mentioned problems of existing ML techniques.

### SUMMARY

An aspect of the present disclosure is to provide a method for determining the state of health of pressurized pipe network to thereby detect, classify, or locate a possible defect that has occurred in the pipe network. The state of health is selected from a plurality of selectable states.

The method comprises: collecting a plurality of TRS's obtained under a plurality of health-related scenarios of the pipe network, respectively, to form a training data set, wherein an individual health-related scenario is an instance of a corresponding selectable state; applying SVD to a trained data matrix to identify a plurality of orthonormal left SVs of the trained data matrix, wherein the trained data matrix is formed by allocating respective TRS's in the plurality of TRS's to either different rows or different columns of the trained data matrix; selecting a subset of the plurality of orthonormal left singular vectors as a plurality of selected SVs such that a least error is obtained in predicting a scenario randomly selected from the plurality of health-related scenarios via projecting a corresponding TRS of the selected scenario onto a SV space spanned by the selected subset; determining a representative location of an individual selectable state in the SV space according to a cluster of locations of one or more first TRS's projected onto the SV space, wherein an individual first TRS is in the training data set, and a corresponding health-related scenario under which the individual first TRS is obtained is an instance of the individual selectable state; obtaining a measured TRS of the pipe network; determining a location of the measured TRS in the SV space; and determining the state of health as a first selectable state in the plurality of selectable states such that the location of the measured TRS in the SV space is closest to the representative location of the first selectable state among respective selectable states in the plurality of selectable states.

In certain embodiments, the plurality of selectable states includes a plurality of defective states, thereby allowing the possible defect to be classified. The plurality of health-related scenarios includes a plurality of defect scenarios.

In certain embodiments, the plurality of defective states includes one or more first defective states each related to a leakage defect in the pipe network.

In certain embodiments, the plurality of defective states includes one or more second defective states each related to a blockage defect in the pipe network.

In certain embodiments, the plurality of selectable states further includes a no-defect state, thereby additionally allowing the possible defect to be detected. The plurality of health-related scenarios further includes an intact case.

In certain embodiments, the plurality of defective states includes plural third defective states related to presence of the possible defect at different locations, respectively, thereby additionally allowing the possible defect to be located.

In certain embodiments, the plurality of selected SVs consists of a first predetermined number of SVs, where the first predetermined number is 2 or 3.

The selecting of the subset of the plurality of orthonormal left SVs as the plurality of selected SVs may comprise: generating plural candidate subsets of the plurality of orthonormal left SVs; and for each of the candidate subsets, computing an average prediction error over predicting a second predetermined number of scenarios randomly selected from the plurality of health-related scenarios, whereby the least error is identified from respective average prediction errors obtained for the candidate subsets.

The second predetermined number may be selected to be half of a total number of scenarios in the plurality of health-related scenarios.

In certain embodiments, the candidate subsets are generated as all possible combinations of a first predetermined number of vectors selected from the plurality of orthonormal left SVs, where the first predetermined number is either 2 or 3.

In certain embodiments, the candidate subsets are generated as all possible combinations of 2 to 3 vectors selected from the plurality of orthonormal left singular vectors.

In certain embodiments, the representative location of the individual selectable state is determined as a centroid of the cluster of locations of the one or more first TRS's in the SV space.

An individual TRS in the plurality of TRS's may be a time response signal or a frequency response signal.

In certain embodiments, the collecting of the plurality of TRS's comprises obtaining a corresponding TRS under the individual health-related scenario by computer simulation according to a calibrated model of the pipe network, whereby the plurality of TRS's is obtained.

In certain embodiments, the collecting of the plurality of TRS's comprises experimentally measuring the plurality of TRS's under the plurality of health-related scenarios, respectively.

In certain embodiments, the collected plurality of TRS's is retrieved from a database that stores a copy of the plurality of TRS's obtained experimentally or by numerical simulation.

Other aspects of the present disclosure are disclosed as illustrated by the embodiments hereinafter.

### BRIEF DESCRIPTION OF THE DRAWINGS

FIG. 1 depicts an exemplary workflow of a supervised ML technique using TRS's for defect detection, classification and location identification in a pressurized pipe network.

FIG. 2 depicts a schematic of a simple Y-branch network considered for illustrating the disclosed technique.

FIG. 3 provides a graphical illustration of projecting training data and test data sets into a 2D SV space for a leak case scenario.

FIG. 4 provides a graphical illustration of projecting training data and test data sets into a 2D SV space for a blockage case scenario.

FIG. 5 provides a graphical illustration of projecting training data and test data sets into a 2D SV space for the case of defect type classification (leaks vs blockages).

FIG. 6 provides a graphical illustration of projecting training data and test data sets into a 3D SV space for the case of defect type classification (leaks vs blockages).

FIG. 7 provides a graphical illustration of projecting training data and test data sets into a 2D SV space for the case of defect location identification.

FIG. 8 provides a graphical illustration of projecting training data and test data sets into a 2D SV space for the case of defective pipe detection under a condition of SNR=1.

FIG. 9 provides a graphical illustration of projecting training data and test data sets into a 3D SV space for the case of defect type classification under a condition of SNR=1.

FIG. 10 provides a graphical illustration of projecting training data and test data sets into a 2D SV space for the case of defect location identification under a condition of SNR=1.

FIG. 11 depicts a schematic of a real-life DMA water-supply system to which the disclosed technique was applied.

FIG. 12 depicts a sketch of a facility setup in the DMA water-supply system shown in FIG. 11.

FIG. 13 depicts example waveforms of collected pressure signals in time domain at the facility setup mentioned in FIG. 12, where the pressure value at start of a transient event is deducted from a measured signal so that the pressure value starts from 0 bar.

FIG. 14 provides a graphical illustration of projecting training data and test data sets into a 2D SV space for the case of defective pipe detection at the aforementioned facility setup, in which a 4-branch pipe network is considered.

FIG. 15 depicts a flowchart showing exemplary steps of a method for determining a state of health of a pressurized pipe network to thereby detect, classify or locate a possible defect occurred in the pipe network, where the method is developed according to the disclosed supervised ML technique.

FIG. 16 depicts a flowchart showing constituent steps of selecting SVs that defines a SV space used in the disclosed method in accordance with certain embodiments of the present disclosure.

### DETAILED DESCRIPTION

The present disclosure introduces a supervised ML technique that uses TRSs to detect defective pipes accurately and robustly in a DMA network with very small (practical) training data sets (up to three simulated defect scenarios in each pipe section) and one single measurement location. The technique has been successfully tested in the presence of noise with a SNR as low as 0 dB, and in the presence of complexities in network topology such as multiple branches and loops. Generally, one measurement point is enough to provide accurate prediction, but additional measurement locations can be added to improve the accuracy, especially in the presence of pipe loops in a water network. Although the main objective of the disclosed technique is to detect defective pipe sections in a DMA network, it is demonstrated that the same approach can be used to identify the defect location within the defective pipe as well as to classify defect types (e.g., blockage or leak).

### A. METHODOLOGY

An overview of the methodology used in the disclosed technique is given as follows. TRSs in pressure measurement are obtained for different potential scenarios of defects or events (of interest to the user e.g., leaks or blockages) in a pipe network. For example, assuming the system is composed of three branched pipes (Y-system), then a transient response is collected while a leak is simulated at the first branch, then another transient response is collected while a leak is simulated at the second branch, and then another transient response is collected while a leak is simulated at the third branch. The data are arranged in an appropriate matrix form and used as a training data set. The collected data can either be the frequency or time response signals of the system. The SVs of the system are obtained by applying SVD on the collected data matrix. A cross-validation stage is then conducted where part of the training data set is randomly selected and projected on the SV space to determine an accuracy of classification and prediction (Brunton and Kutz 2019). Test measurements or newly collected TRSs from the network are projected on the previously-identified SV space and the results indicate the state of the pipe network system (e.g., defective, or healthy) and classify the defects or events (if any) according to trained clusters in the SV space. The same procedure can be further applied to the defective pipe with refined measurements to identify the defect location.

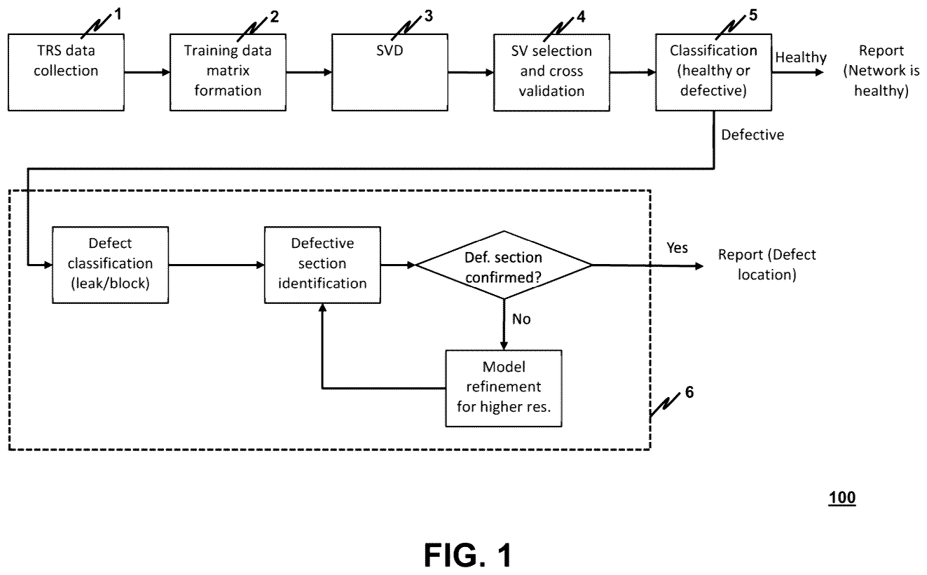

The disclosed technique is elaborated as follows with the aid of FIG. 1, which depicts an exemplary workflow 100 of the disclosed technique.

### A.1. Step 1: Data Collection

TRSs are obtained for different potential scenarios of defects or events (of interest to the user e.g., leaks or blockages) in the pipe network. A TRS means that a transient pressure wave is generated in the fluid by a pipeline operator from a desired location in the pipe network and with a desired excitation waveform, then the response of the system to such wave is measured (pressure measurement). For example, assuming the system is composed of three branched pipes (Y-system) and the pipeline operator is interested in leak detection, then the data are collected as follows.

Intact case. A TRS is collected when no simulated defect exists in the system.

Leak i in pipe j case. A TRS is collected while the ith simulated leak exits in pipe j (j=1, 2 or 3 in this Y-system case). Usually, up to 3 leaks in a single pipe j are enough. Preferably, the locations of these three simulated leaks are set as follows: two are within a wavelength from the upstream and downstream boundaries of pipe section j, and one is at intermediate position (e.g., midsection).

In general, if the interest is to detect other types of defects, then further data are collected as follows.

Defect i in pipe j case. A TRS is collected while the ith simulated defect exits in pipe j (j=1, 2, or 3 in this Y-system case). Usually, up to 3 leaks in a single pipe j are enough. Preferably, the locations of these three simulated defects are set as follows: two are within a wavelength from the upstream and downstream boundaries of pipe section j, and one is at intermediate position (e.g., midsection).

### A.2. Step 2: Training Data Set Arrangement

The collected data can either be frequency response signals or time response signals of the system. The data are arranged in appropriate matrix form as follows:

$${M}_{D} = \qquad ( 1 )$$

$$\begin{matrix}intact \\ ⋮ \\ leak i in pipe j \\ ⋮ \\ ⋮ \\ defect i in pipe j \\ ⋮\end{matrix} [ \begin{matrix}{P}^{0} ( 1 ) & {P}^{0} ( 2 ) & … & {P}^{0} ( n ) & … & {P}^{0} ( N ) \\ ⋮ & ⋮ & ⋮ & ⋮ & ⋮ & ⋮ \\ {P}_{i}^{j} ( 1 ) & {P}_{i}^{j} ( 1 ) & … & {P}_{i}^{j} ( n ) & … & {P}_{i}^{j} ( N ) \\ ⋮ & ⋮ & ⋮ & ⋮ & ⋮ & ⋮ \\ ⋮ & ⋮ & ⋮ & ⋮ & ⋮ & ⋮ \\ {P}_{i}^{j} ( 1 ) & {P}_{i}^{j} ( 1 ) & … & {P}_{i}^{j} ( n ) & … & {P}_{i}^{j} ( N ) \\ ⋮ & ⋮ & ⋮ & ⋮ & ⋮ & ⋮\end{matrix} ] = [ \begin{matrix}{P}_{intact}^{0} \\ ⋮ \\ {P}_{leak i}^{j} \\ ⋮ \\ ⋮ \\ {P}_{defect i}^{j} \\ ⋮\end{matrix} ]$$

where Pᵢ^{j}(n) is the pressure measurement of the ith simulated defect case in the jth pipe section at the nth sampling point (in time or frequency). The matrix M_{D} is referred to as a trained data matrix. An index vector (I_{D}) is associated with different training case scenarios. For example, with I_{D}=[0, 1, 2, 3], index 0 refers to an intact (no defect) case, index 1 refers to a leak in pipe 1, index 2 refers to a leak in pipe 2, and index 3 refers to a leak in pipe 3. Thus, the following trained data matrix M_{D},

$${M}_{D} = \begin{matrix}intact 1 \\ intact 2 \\ leak 1 in pipe 1 \\ leak 2 in pipe 1 \\ leak 1 in pipe 2 \\ leak 1 in pipe 3 \\ leak 2 in pipe 3\end{matrix} = [ \begin{matrix}{P}_{intact}^{0} \\ {P}_{intact}^{0} \\ {P}_{leak 1}^{0} \\ {P}_{leak 2}^{1} \\ {P}_{leak 1}^{2} \\ {P}_{leak 1}^{3} \\ {P}_{leak 3}^{3}\end{matrix} ] , \qquad ( 2 )$$

has the following index vector:

I_{D}=[0 0 1 1 2 3 3]* (3)

where the superscript * denotes the transpose.

### A.3. Step 3: SV Space and Projection

A SVD is applied to the trained data matrix M_{D} to obtain SVs of the system. We name the SVs as eigen-TRs of the pipe network. The primary property of an eigen-TR is the fact that it represents data on an orthogonal basis with distinct features, which allows for defects/events identification and classification. The features needed to characterize or classify a certain defect or event are usually clear in a low subspace (i.e. projection of data sets on 2 or 3 SVs is sufficient to classify the defect). The SVD provides the following:

$${M}_{D} = \qquad ( 4 )$$

$$U Σ {V}^{*} = {\underbrace{[ \begin{matrix}{U}_{1} & … & {U}_{i} & … & {U}_{k}\end{matrix} ]}}_{U} {\underbrace{[ \begin{matrix}{σ}_{1} & 0 & … \\ 0 & ⋱ & 0 \\ ⋮ & 0 & {σ}_{k}\end{matrix} ]}}_{Σ} {\underbrace{{[ \begin{matrix}{V}_{1} & … & {V}_{i} & … & {V}_{k}\end{matrix} ]}^{*}}}_{{V}^{*}}$$

where Σ is a matrix of singular values (σ₁ . . . σₖ), U is a matrix of orthonormal left singular vectors (U₁ . . . Uₖ), V is a matrix of orthonormal right singular vectors (V₁ . . . Vₖ), and superscript * denotes matrix transpose. Note that U₁ . . . Uₖ, V₁ . . . Vₖ are column vectors. Projecting rows of the trained data matrix onto the first and second right singular vectors (eigen-TRs) and normalizing by the corresponding singular values give the corresponding SV vectors (left SVs):

$$\frac{{M}_{D} {V}_{1}}{{σ}_{1}} = {U}_{1} ; \frac{{M}_{D} {V}_{2}}{{σ}_{2}} = {U}_{2} . \qquad ( 5 )$$

The length of Uₖ corresponds to the number of scenarios. For example, assume that the trained data matrix is collected in time domain, then U₁(1) is the projection of the time series signal measured for the first scenario (i.e. intact case) on V₁ and normalized by σ₁. Similarly, U₂(1) is the projection of the time series signal measured for the first scenario (i.e. intact case) on V₂, and normalized by σ₂. Therefore, (U₁(1), U₂(1)) is a projection coordinate in the space of SVs 1 and 2. The coordinate (U₁(1), U₂(1)) specifies the location of the time series signal of the first scenario in the SV space defined by SVs 1 and 2. Projection can be made onto any right SV, but projection in a low-order space (2-3 modes) is usually sufficient to identify defect signatures.

### A.4. Step 4: Selection of Appropriate SVs and Cross-Validation

The choice of SVs is not straightforward. The conventional notion that the first SVs corresponding to the highest singular values give the best classification results is not necessarily true in the technical problem considered in the present disclosure. The distinct defect features in pressurized pipe systems may be found in high-order eigen-TRs. To select the most appropriate SVs, cross-validation is conducted for different SV combinations and the one that results in the minimum prediction error is selected. An algorithm named “bestSV” is developed to conduct the step 4 (see Algorithm 1 below). An input to the algorithm is the number of SVs (N_{SV}). Thus, N_{SV} needs to be pre-defined when using the “bestSV” algorithm. A systematic variation of N_{SV} can be conducted until a minimum error from the cross-validation step is achieved. Although found empirically, N_{SV}=2 or 3 can provide accurate classification.

The cross-validation is conducted by randomly selecting several (Nₚₑᵣₘ) (about half of the training data set) scenarios from the trained data and classifying them by projection into the SV space (as described in the step 3) using Algorithm 2″ (see step 5). This step is repeated N_{CV} times to obtain the minimum error.

Algorithm 1: Best SV algorithm.

Input: U, idx, N_{SV}, Nₚₑᵣₘ, N_{CV}
Output: U_{SV}, best combination, minimum error
Steps:

| | |
|---|---|
| 1. | Extract all possible combination (C) of N_{SV} vectors from U. |
| 2. | Try different SV combinations 1-by-1. |
| 3. | For c ∈ C { |
| | 3.1. Conduct cross validation for each combination. |
| | 3.2. For i_{CV} ∈ N_{CV} { |
| | 3.2.1. Randomly select Nₚₑᵣₘ columns of SVs from existing |
| | training data set for cross validation. |
| | 3.2.2. Attribute the randomly selected SVs to a test case T, and |
| | mark down the index of the randomly selected defective pipe test |
| | case (referred to as true index). |
| | 3.2.3. Classify the randomly selected test cases for cross |
| | validation. |
| | 3.2.4. Measure the difference between the classified random test |
| | index and the true index. |
| | 3.2.5. Compute error of cross validation. } |
| | 3.3. Compute the average error. |
| | 3.4. Compute the standard deviation of errors. } |
| 4. | Get and display minimum error. |
| 5. | Get and display the best combination corresponding to the minimum |
| | average. |
| 6. | Get corresponding SV vectors (U_{SV}). |

### A.5. Step 5: Classification by Mean

The choice of the best SVs and their number is discussed in the step 4. Once the choice is made, the entire trained data matrix is projected into the selected SV space (e.g., SV1 and SV2 space to form the best SV vector (U_{best})). The data set for each case scenario is considered as a known data cluster. Then, the centroid of each cluster of data is measured. Finally, the test data set (T) is projected into the SV space and the distance between each test scenario and the centroids are computed. The index of the cluster corresponding to the minimum distance is chosen as the classified defect output. The classification is conducted by Algorithm 2.

Algorithm 2: Classification by mean.

Input: T, U_{best}, idx
Output: T_class, G, norm_dist
Steps:

| | |
|---|---|
| 1. | Sort out the clusters of data in the space of best of selected best SVs |
| | according to the defect index (idx) of trained data (e.g., simulated |
| | defective pipe number). |
| 2. | Get the number of clusters (N_{C}). |
| 3. | Compute the centroid of each cluster (G). |
| 4. | Compute the standard deviation of the centroids (norm_dist). |
| 5. | Measure the distance between the centroid of each cluster and the |
| | projected test case (G-T) and normalize it by norm_dist to make the |
| | variability of data along different SVs with the same order of |
| | magnitude. |
| 6. | Sort the distances from lowest to highest. |
| 7. | Select the defect index corresponding to the lowest distance |
| | (T_class). |

### A.6. Step 6: Defect Detection and Classification

The output “T_class” in Algorithm 2, representing the defect index corresponding to the lowest distance, indicates: (I) the defective pipe index (if any) or intact case index; or (II) defect type index; or (III) defect location index.

Case (I): The defective pipe index (if any) or intact case index is provided by Algorithm 2 if the disclosed technique is applied to the pipe network for defective pipe detection.

Case (II): The defect type index is provided by Algorithm 2 if the disclosed technique is applied to the pipe network for defect type classification. For example, classifying a leak or blockage case will have the following trained data matrix and index vector:

$${M}_{D} = \begin{matrix}leak \\ leak \\ leak \\ leak \\ blockage \\ blockage \\ blockage\end{matrix} = [ \begin{matrix}{P}_{leak 1}^{1} \\ {P}_{leak 2}^{1} \\ {P}_{leak 1}^{2} \\ {P}_{leak 1}^{3} \\ {P}_{blockage 1}^{1} \\ {P}_{blockage 1}^{2} \\ {P}_{blockage 1}^{3}\end{matrix} ] and {I}_{D} = [ \begin{matrix}1 \\ 1 \\ 1 \\ 1 \\ 2 \\ 2 \\ 2\end{matrix} ] . \qquad ( 6 )$$

Case (III): The defect location index is provided by Algorithm 2 if the disclosed technique is applied to the pipe network for defect localization (after a defective pipe j is identified). For example, defect (e.g., a leak) localization would have the following trained data matrix and index vector:

$${M}_{D} = \begin{matrix}leak at {x}_{1} ( m ) \\ leak at {x}_{2} ( m ) \\ leak at {x}_{3} ( m ) \\ leak at {x}_{4} ( m ) \\ leak at {x}_{5} ( m ) \\ leak at {x}_{6} ( m ) \\ leak at {x}_{7} ( m )\end{matrix} = [ \begin{matrix}{P}_{leak 1}^{j} \\ {P}_{leak 2}^{j} \\ {P}_{leak 3}^{j} \\ {P}_{leak 4}^{j} \\ {P}_{leak 5}^{j} \\ {P}_{leak 6}^{j} \\ {P}_{leak 7}^{j}\end{matrix} ] and {I}_{D} = [ \begin{matrix}1 \\ 2 \\ 3 \\ 4 \\ 5 \\ 6 \\ 7\end{matrix} ] . \qquad ( 7 )$$

### A.7. Performance Metrics

To evaluate the effectiveness of our proposed method, the following three key metrics are used: precision, recall, and the F1 score (Yacouby & Axman, 2020). Individually, each metric provides unique insights into the model's performance. Collectively, they form a robust framework for assessing the defect detection system's efficacy, facilitating a thorough analysis across diverse scenarios.

### B. APPLICATION AND IMPLEMENTATION EXAMPLES

### B.1. Example 1: Detection and Identification of Defective Branch Pipe in Y-Network System

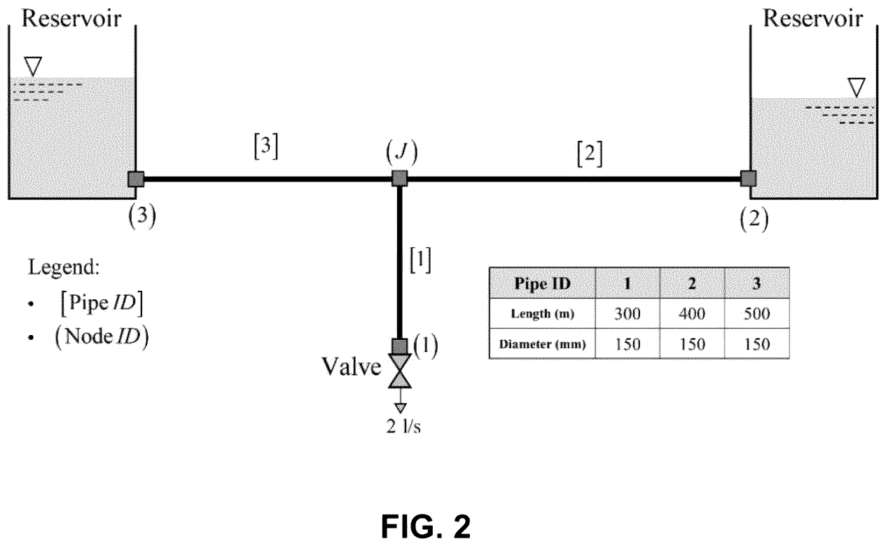

Consider a numerical test case for a Y-branched pipe system as shown in FIG. 2. The pressure, flow, wave speed, length, and diameter of each pipe branch (j) are denoted by pⱼ, qⱼ, aⱼ, Lⱼ, dⱼ, respectively where j=1, 2, or 3. The scenarios considered here are an intact (no defect) system, a leaking system, and a system with a discrete blockage. The size of the defects is considered small to show the accuracy and capability of the method. “Small” defect means that the transient wave reflection amplitude from such defect is less than 0.5 m of pressure head while the injected transient pressure head is about 20 m.

In this example, only one defect in each pipe of the network shown in FIG. 2 is considered. Initially, the valve at node 1 is opened with initial flow q1=2 Ls⁻¹. This valve is closed within 0.02 s to generate a transient wave into the system. The pipe material is assumed elastic and the elasticity of the material is considered by modifying the wave speed. In this case, the wave speed is taken to be 1000 ms⁻¹. It is important to note that the disclosed technique can be applied to a system with varying wave speed and/or different pipe materials. The steady-state pressure head is around 30 m and the transient pressure head is about 20 m.

Step 1: Data measurement. A numerical model based on the MOC is used to simulate different scenarios. Only one measurement location is considered for this case which is taken at node 1 (see FIG. 2). The collected data is pressure signals in time. The minimum time length of the signal is 2×(L₁+max(L₂, L₃)/min(a₁, a₂, a₃)). The indices for the four considered scenarios are: (0) for an intact case (no leak), (1) for a leak in pipe 1, (2) for a leak in pipe 2, and (3) for a leak in pipe 3. Training data include three simulated leaks in each pipe branch, and test data include two simulated leaks in each pipe branch (chosen at a location different from the training data cases). The test cases are summarized in Table 1.

TABLE 1
Simulated leak scenarios.

| | Length | Training Leaks | | | | Testing Leaks | |
|---|---|---|---|---|---|---|---|
| | of pipe | (Distance from | | | | (Distance from | |
| | section | the junction) | | | | the junction) | |
| Pipe 1 | 300 m | 225 m | 150 m | 75 | m | 187 m | 112 m |
| Pipe 2 | 400 m | 300 m | 200 m | 100 | m | 250 m | 150 m |
| Pipe 3 | 500 m | 375 m | 250 m | 125 | m | 312 m | 187 m |

Step 2: Training data set arrangement. The training data set is collected into the following matrix form with their corresponding index vectors:

$${M}_{D} = \begin{matrix}intact \\ leak 1 in pipe 1 \\ leak 2 in pipe 1 \\ leak 3 in pipe 1 \\ leak 1 in pipe 2 \\ leak 2 in pipe 2 \\ leak 3 in pipe 2 \\ leak 1 in pipe 3 \\ leak 2 in pipe 3 \\ leak 3 in pipe 3\end{matrix} = [ \begin{matrix}{P}_{intact}^{0} \\ {P}_{leak 1}^{1} \\ {P}_{leak 2}^{1} \\ {P}_{leak 3}^{1} \\ {P}_{leak 1}^{2} \\ {P}_{leak 2}^{2} \\ {P}_{leak 3}^{2} \\ {P}_{leak 1}^{3} \\ {P}_{leak 2}^{3} \\ {P}_{leak 3}^{3}\end{matrix} ] and {I}_{D} = [ \begin{matrix}0 \\ 1 \\ 1 \\ 1 \\ 2 \\ 2 \\ 2 \\ 3 \\ 3 \\ 3\end{matrix} ] . \qquad ( 8 )$$

Similarly, the training data and its corresponding training indices are given as:

$$T = \begin{matrix}test leak 1 in pipe 1 \\ test leak 2 in pipe 1 \\ test leak 1 in pipe 2 \\ test leak 2 in pipe 2 \\ test leak 1 in pipe 3 \\ test leak 2 in pipe 3\end{matrix} = [ \begin{matrix}{P}_{test leak 1}^{1} \\ {P}_{test leak 2}^{1} \\ {P}_{test leak 1}^{2} \\ {P}_{test leak 2}^{2} \\ {P}_{test leak 1}^{3} \\ {P}_{test leak 2}^{3}\end{matrix} ] and {I}_{T} = [ \begin{matrix}1 \\ 1 \\ 2 \\ 2 \\ 3 \\ 3\end{matrix} ] . \qquad ( 9 )$$

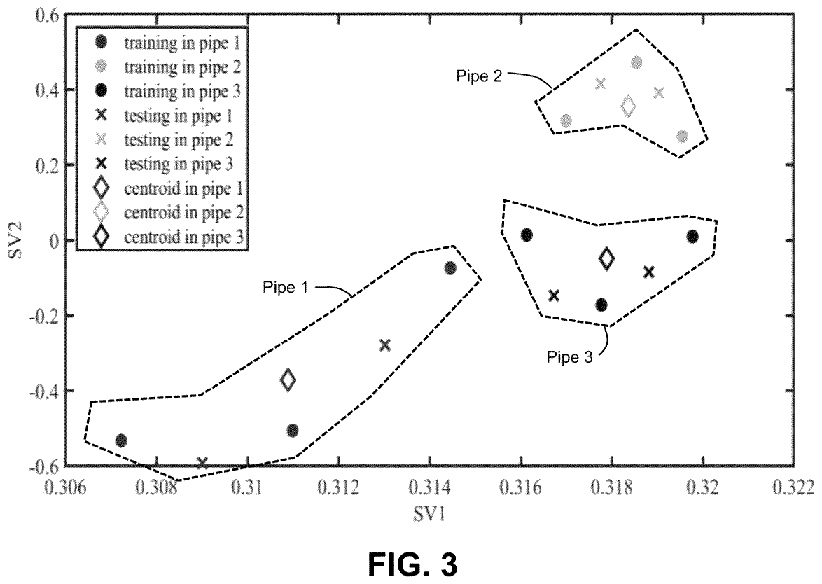

The SVs are obtained by applying the SVD to the trained data matrix (the step 3). Executing Algorithm 1 (the step 4) provides the best pair of SVs which are, in this case, SV1 and SV2. Then, Algorithm 2 is executed (the step 5) where the test data set is projected into the chosen SV space, and the results of the defective pipe index are given in Table 2. All test cases are predicted accurately with the performance metrics: Precision=1.0, Recall=1.0, and F1 score =1.0. For graphical illustration, FIG. 3 plots the projection of the training data set and corresponding centroids (see Algorithm 2), and the test data set. Each scenario is labeled: intact; a leak in pipe 1; a leak in pipe 2; and a leak in pipe 3. The training data projection is represented with dot-points, and their corresponding centroids are indicated by a diamond shape. The projection of the test data set is indicated by cross marks.

It is instructive to mention that the accuracy of the disclosed technique may reduce for cases where the test defect is close to the pipe junction. However, such an effect may be compensated by increasing the size of the training data set. In practice, accurate prediction resolution is possible for defects placed within one wavelength away from the pipe junction.

TABLE 2
The outcome of Algorithm 2: leaking-type defective pipe index.

| | | | | | | |
|---|---|---|---|---|---|---|
| True defective pipe index | 1 | 1 | 2 | 2 | 3 | 3 |
| Predicted defective pipe index | 1 | 1 | 2 | 2 | 3 | 3 |

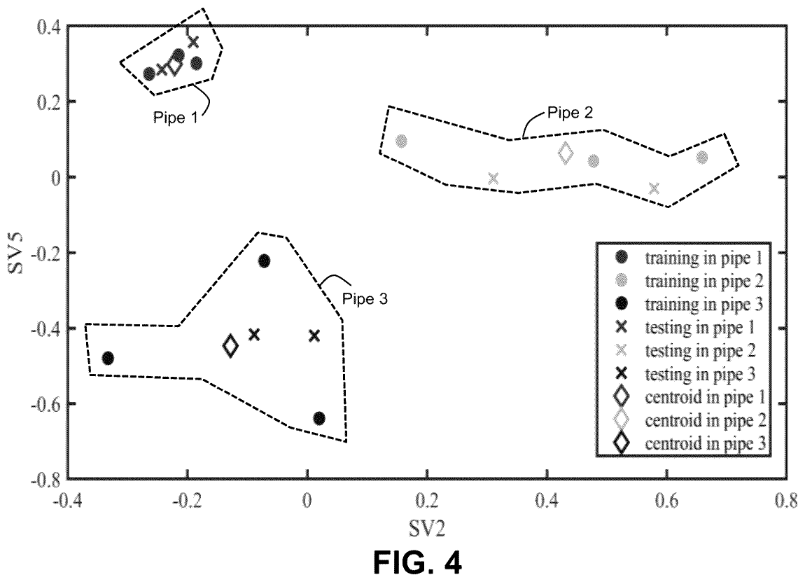

The same application can be repeated for the case of blockages (local dampers). A damper can represent a discrete blockage or a malfunctioning device (e.g., a valve that is partially closed but assumed to be fully opened). Taking the defect location for training and testing data set cases, the disclosed technique provides a 100% accuracy of blockage-type defective pipe (Table 3). In this case, the “bestSV” algorithm (see Algorithm 1 in the step 4) shows that SV2 and SV5 are the best SV pairs. The performance metrics in this case are: Precision=1.0, Recall=1.0, and F1 score=1.0. The graphical representation of data projection is shown in FIG. 4.

TABLE 3
Outcome of Algorithm 2: blockage-type defective pipe index.

| | | | | | | |
|---|---|---|---|---|---|---|
| True blockage-type defective pipe index | 1 | 1 | 2 | 2 | 3 | 3 |
| Predicted blockage-type defective pipe index | 1 | 1 | 2 | 2 | 3 | 3 |

### B.2. Example 2: Defect Type Classification-Leak Vs Blockage

Consider the same Y-network system in example 1. Classification of defect type is conducted by collecting training data set with scenarios that include both leak and blockage cases (other defects can also be included, but this example studies these most common defect types encountered in water supply systems). The trained data matrix and their corresponding index vectors are given as follows:

$${M}_{D} = [ \begin{matrix}{M}_{L} \\ {M}_{B}\end{matrix} ] and [ \begin{matrix}{I}_{L} \\ {I}_{B}\end{matrix} ] \qquad ( 10 )$$

$$where :$$

$${M}_{L} = \begin{matrix}leak 1 in pipe 1 \\ leak 2 in pipe 1 \\ leak 3 in pipe 1 \\ leak 1 in pipe 2 \\ leak 2 in pipe 2 \\ leak 3 in pipe 2 \\ leak 1 in pipe 3 \\ leak 2 in pipe 3 \\ leak 3 in pipe 3\end{matrix} = [ \begin{matrix}{P}_{leak 1}^{1} \\ {P}_{leak 2}^{1} \\ {P}_{leak 3}^{1} \\ {P}_{leak 1}^{2} \\ {P}_{leak 2}^{2} \\ {P}_{leak 3}^{2} \\ {P}_{leak 1}^{3} \\ {P}_{leak 2}^{3} \\ {P}_{leak 3}^{3}\end{matrix} ] and {I}_{L} = [ \begin{matrix}L \\ L \\ L \\ L \\ L \\ L \\ L \\ L \\ L\end{matrix} ] ; \qquad ( 11 a )$$

$$and$$

$${M}_{B} = \begin{matrix}blockage 1 in pipe 1 \\ blockage 2 in pipe 1 \\ blockage 3 in pipe 1 \\ blockage 1 in pipe 2 \\ blockage 2 in pipe 2 \\ blockage 3 in pipe 2 \\ blockage 1 in pipe 3 \\ blockage 2 in pipe 3 \\ blockage 3 in pipe 3\end{matrix} = [ \begin{matrix}{P}_{blockage 1}^{1} \\ {P}_{blockage 2}^{1} \\ {P}_{blockage 3}^{1} \\ {P}_{blockage 1}^{2} \\ {P}_{blockage 2}^{2} \\ {P}_{blockage 3}^{2} \\ {P}_{blockage 1}^{3} \\ {P}_{blockage 2}^{3} \\ {P}_{blockage 3}^{3}\end{matrix} ] and {I}_{B} = [ \begin{matrix}B \\ B \\ B \\ B \\ B \\ B \\ B \\ B \\ B\end{matrix} ] . \qquad ( 11 b )$$

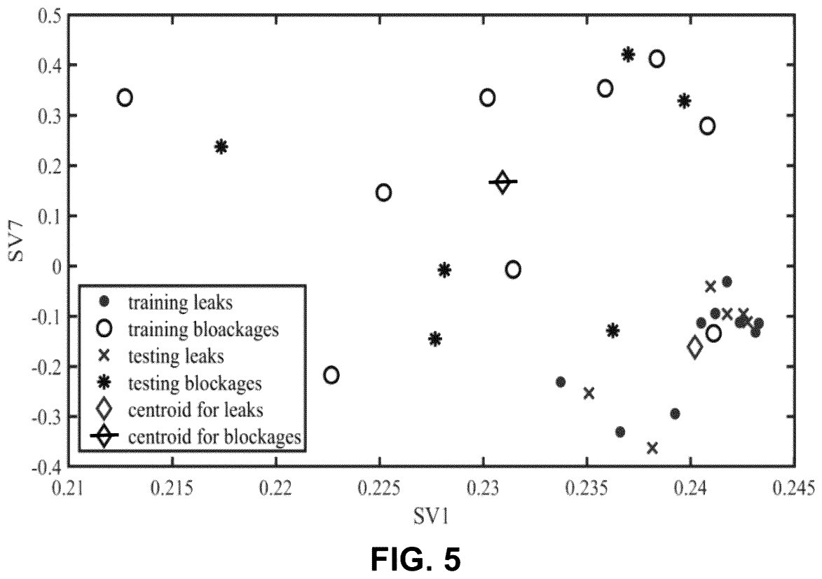

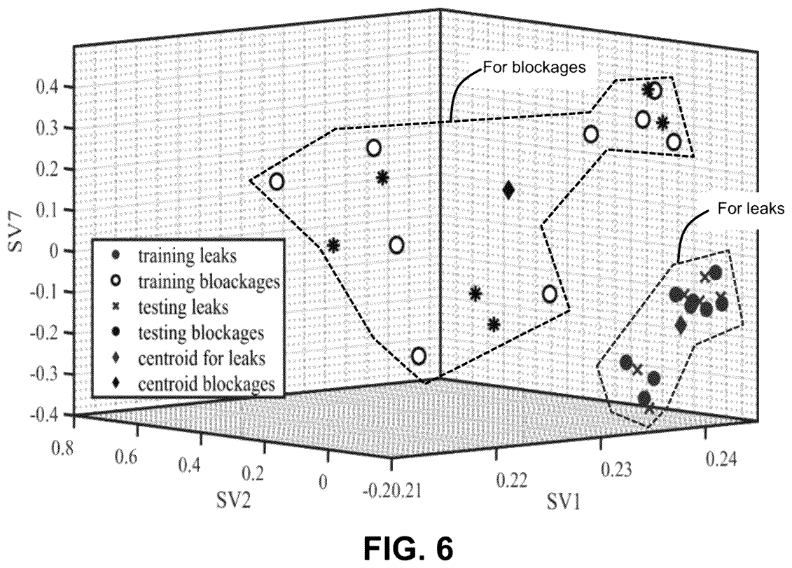

The training and test data sets are the same as the ones used in the previous Y-branch examples. Therefore, six leak tests and six blockage tests will be used. Using Algorithm 1 (the step 4), the best pair of SVs are SV1 and SV7. The defect classification is obtained by executing Algorithm 2 using the test data sets. The classification results are given in Table 4, which shows accurate identification except for one blockage case. The performance metrics in this case are: (i) Precision=0.86, Recall=1.0, and F1 score=0.92 for leaks; and Precision=1.0, Recall=0.8, and F1 score=0.89 for blockages. Limitations can be compensated by considering a 3D SV space (i.e. projection into three SVs space). In this case, Algorithm 1 shows that SV1, SV2, and SV7 are the best singular vectors, and the results from the classification Algorithm 2 are shown in Table 5. With this refinement, the performance metrics for both leaks and blockages are Precision=Recall=F1 score=1.0. The graphical representation of data projection is shown in FIGS. 5 and 6.

TABLE 4
The outcome of Algorithm 2: Defects classification
(leaks (L) vs blockages (B)).

| | | | | | | | | | | | | |
|---|---|---|---|---|---|---|---|---|---|---|---|---|
| True defect | L | L | L | L | L | L | B | B | B | B | B | B |
| type index | | | | | | | | | | | | |
| Predicted | L | L | L | L | L | L | B | B | B | L | B | B |
| defect type | | | | | | | | | | | | |
| index | | | | | | | | | | | | |

TABLE 5
The outcome of Algorithm 2: Defects classification
(leaks vs blockages) in 3D SV space.

| | | | | | | | | | | | | |
|---|---|---|---|---|---|---|---|---|---|---|---|---|
| True defect | L | L | L | L | L | L | B | B | B | B | B | B |
| type index | | | | | | | | | | | | |
| Predicted | L | L | L | L | L | L | B | B | B | B | B | B |
| defect type | | | | | | | | | | | | |
| index | | | | | | | | | | | | |

### B.3. Example 3: Defect Location Identification

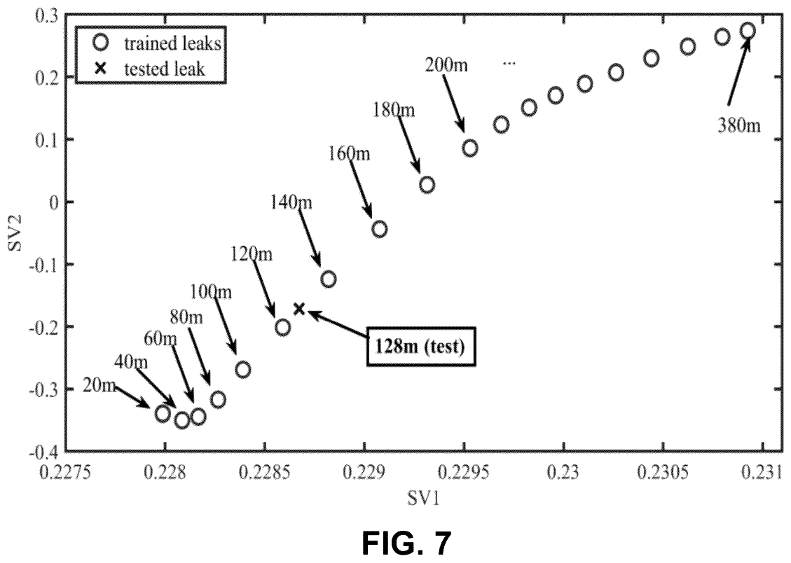

Once a defective pipe is detected (see examples 1 and 2), the disclosed technique can also be applied for defect localization as a follow-up stage. It can be done by refining the locations of training data set in the defective pipe branch. For example, consider that pipe 2 in the previous Y-system case is detected as defective pipe branch. Numerical test cases with multiple simulated defects (e.g., leak) candidates in pipe 2 are conducted and data is collected in the following matrix form with corresponding index vector as described in the step 6 (defect detection and classification). The number of potential defect candidates would depend on the transient wavelength (λ) generated. Since the resolution is limited with the diffraction limit (i.e. λ/2) (Waqar et al. 2022), the spacing between various simulated defect candidates is set to be every λ/2 or higher. In this case, the leak simulations are spaced by 20 m (≈λ). Applying Algorithm 1 shows that the best SVs are SV1 and SV2, and the leak localization is obtained using Algorithm 2. The result is given in Table 6, and the graphical representation of the data projection is shown In FIG. 7.

TABLE 6
Outcome of Algorithm 2: Defects localization.

| | |
|---|---|
| True leak location | 128 m |
| Predicted leak location | 120 m |

### B.4. Example 4: Noise Effect

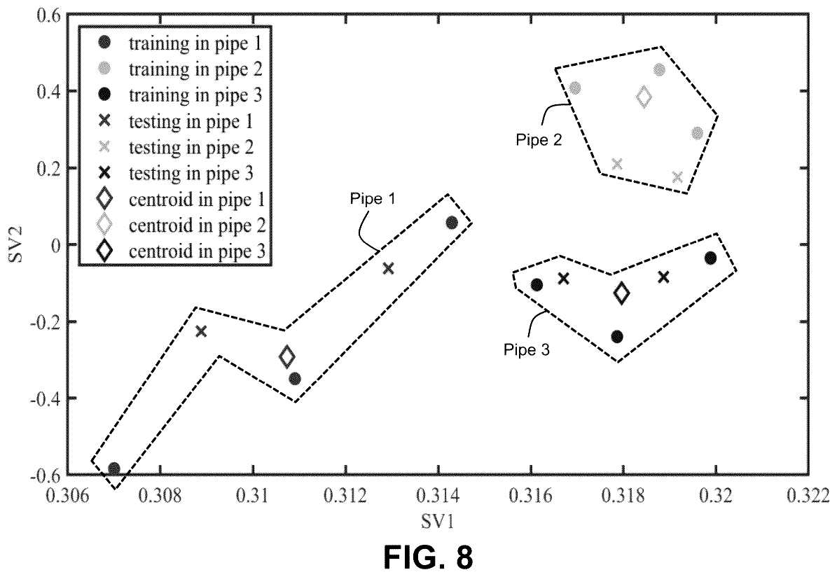

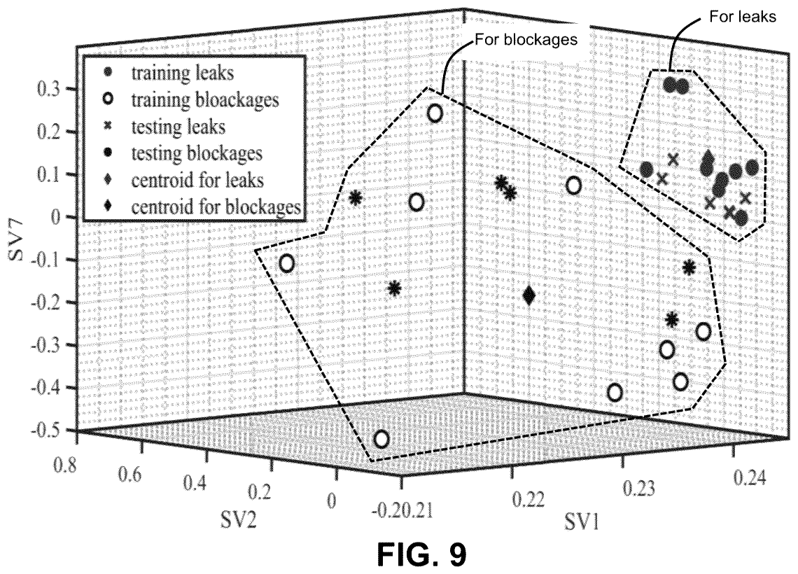

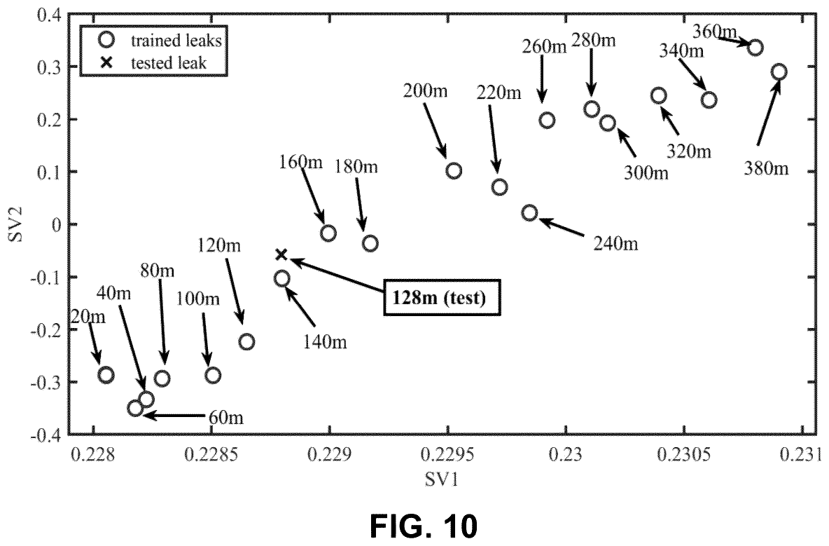

Consider the same test cases used in the previous examples. To illustrate the application of the disclosed technique in a noisy environment, a Gaussian distributed noise is added artificially to the numerical data. Such noise distribution is quite representative to the real noise distribution in real-field pressurized pipe systems (Dubey et al. 2019). The SNR is defined as the ratio between the average amplitude of reflections from defects in different scenarios (i.e. about 0.25 m pressure head) and the standard deviation of the noise. In this example, we consider the case for SNR=1. The results for defective pipe detection, defect type classification and defect location identification are presented in Tables 7, 8 and 9, respectively. In terms of performance indices, the following values are obtained: (i) Table 7: Precision=1.0, Recall=0.83, F1 score=0.91; and (ii) Table 8: (for both leaks and blockages), Precision=Recall=F1 score=1.0. The corresponding graphical representations of the data projections are shown in FIGS. 8, 9 and 10, respectively. Slight errors are induced in defective pipe detection and defect localization. Nevertheless, the accuracy of the method can be improved by increasing measurement locations, training data set, and/or the SV space dimension.

TABLE 7
Outcome of Algorithm 2: leaking-type
defective pipe index (SNR = 1).

| | | | | | | |
|---|---|---|---|---|---|---|
| True defective pipe index | 1 | 1 | 2 | 2 | 3 | 3 |
| Predicted defective pipe index | 1 | 1 | 0 | 2 | 3 | 3 |

TABLE 8
Outcome of Algorithm 2: Defects classification
(leaks vs blockages) in 3D SV space (SNR = 1).

| | | | | | | | | | | | | |
|---|---|---|---|---|---|---|---|---|---|---|---|---|
| True defect | L | L | L | L | L | L | B | B | B | B | B | B |
| type index | | | | | | | | | | | | |
| Predicted | L | L | L | L | L | L | B | B | B | B | B | B |
| defect type | | | | | | | | | | | | |
| index | | | | | | | | | | | | |

TABLE 9
Outcome of Algorithm 2: Defects localization (SNR = 1).

| | |
|---|---|
| True leak location | 128 m |
| Predicted leak location | 140 m |

### B.5. Example 5: DMA Scale

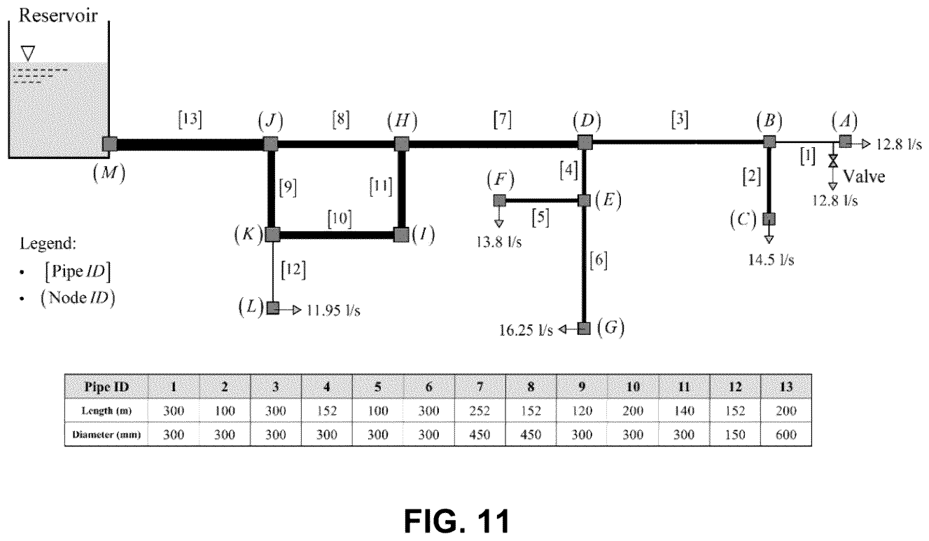

In this example, we consider a DMA case where the pipe layout is designed to have a similar layout as the real Anderson Road Quarry (ARQ) development site in Hong Kong (District Council 2020) but with minor simplifications (schematic shown in FIG. 11). The numerical model assumes that the bends and the pipe topology effect on the transient wave is negligible and assumes constant discharges at demand nodes. The former assumption is justified by the fact that the transient wavelength generated is much larger than the bend length scale, while the latter assumption is validated by the fact that the time scale of flow variation in real water supply systems (order of hours) is much larger than the time scale of transient waves (order of seconds). Therefore, during a transient test/event, the nodal demands appear constant (the case of passive fast transient (Meniconi et al., 2021) occurring during the active transient test events are ignored). The pipe system is composed of a reservoir that supplies water to a pipe network composed of thirteen pipe sections including a loop and five demand points at the boundaries. The pipe material is ductile iron, and the wave speed is assumed constant throughout the system and taken to be equal to an average value of 1000 ms⁻¹. The flow capacity of the system is taken as 50 Ls⁻¹. The transient is generated from a side discharge valve at pipe branch 1 (FIG. 11).

The training data set is collected for different leak scenarios as follows: three leaks scenarios in each pipe located in the upstream, middle, and downstream of each pipe section, corresponding to be at 25%, 50%, and 75% of the length of each pipe section. In total, the training data set consists of 3×13=39 leak cases. The index vector is given by: I_{D}=[0, 0, 1, 1, 1, 2, 2, 2, 3, 3, 3, 4, 4, 4, 5, 5, 5, 6, 6, 6, 7, 7, 7, 8, 8, 8, 9, 9, 9, 10, 10, 10, 11, 11, 11, 12, 12, 12, 13, 13, 13]. The test data set includes 13 leak cases (one leak case in each pipe branch). The leak locations for both training and test cases are summarized in Table 10. The outcome results of the disclosed technique after using Algorithms 1 and 2 are given in Table 11. The performance metrics indicate that, for no noise case, Precision=Recall=F1 score=0.93, and for the case when noise is present, Precision=0.78, Recall=0.64, and F1 score=0.7. For all test cases, the disclosed technique has accurately classified the defective test pipe except for pipe section 12. The error in misclassifying the defective pipe section 12 is due to the presence of a loop which induces redundancy and complicates the transient response. In fact, the case of a noisy environment (Table 11) shows that the error in detecting defective pipes within the loop is challenging. Nevertheless, pipes 8, 9, 10 and 11 represent the loop, and thus the disclosed technique is able to identify a defect in the loop. To improve the accuracy and localization, further refinement of training data can be conducted as shown in previous examples.

TABLE 10
Summary of leak locations for training and test data sets.

| Pipe | Pipe | Training leak | | | Testing leak |
|---|---|---|---|---|---|
| ID | length | location (m) | | | location (m) |
| 1 | 300 | 75 | 150 | 250 | 120 |
| 2 | 100 | 25 | 50 | 75 | 60 |
| 3 | 300 | 75 | 150 | 225 | 200 |
| 4 | 152 | 38 | 76 | 114 | 91 |
| 6 | 100 | 25 | 50 | 75 | 40 |
| 6 | 300 | 75 | 150 | 200 | 175 |
| 7 | 252 | 53 | 117 | 180 | 94 |
| 8 | 152 | 38 | 76 | 114 | 61 |
| 9 | 120 | 30 | 60 | 90 | 40 |
| 10 | 200 | 50 | 100 | 150 | 80 |
| 11 | 140 | 30 | 60 | 90 | 80 |
| 12 | 152 | 38 | 76 | 114 | 91 |
| 13 | 200 | 50 | 100 | 150 | 85 |

TABLE 11
Outcome of Algorithm 2: Defective
pipe detection in DMA network case.

| | | | | | | | | | | | | | |
|---|---|---|---|---|---|---|---|---|---|---|---|---|---|
| True | 1 | 2 | 3 | 4 | 5 | 6 | 7 | 8 | 9 | 10 | 11 | 12 | 13 |
| defective | | | | | | | | | | | | | |
| pipe index | | | | | | | | | | | | | |
| Predicted | 1 | 2 | 3 | 4 | 5 | 6 | 7 | 8 | 9 | 10 | 11 | 13 | 13 |
| defective | | | | | | | | | | | | | |
| pipe index | | | | | | | | | | | | | |
| Predicted | 1 | 2 | 3 | 4 | 5 | 6 | 7 | 8 | 8 | 11 | 11 | 0 | 0 |
| defective | | | | | | | | | | | | | |
| pipe index | | | | | | | | | | | | | |
| (SNR = 1) | | | | | | | | | | | | | |

### B.6. Example 6: Experimental Test at Field Scale Beacon Hill (BH) Facility

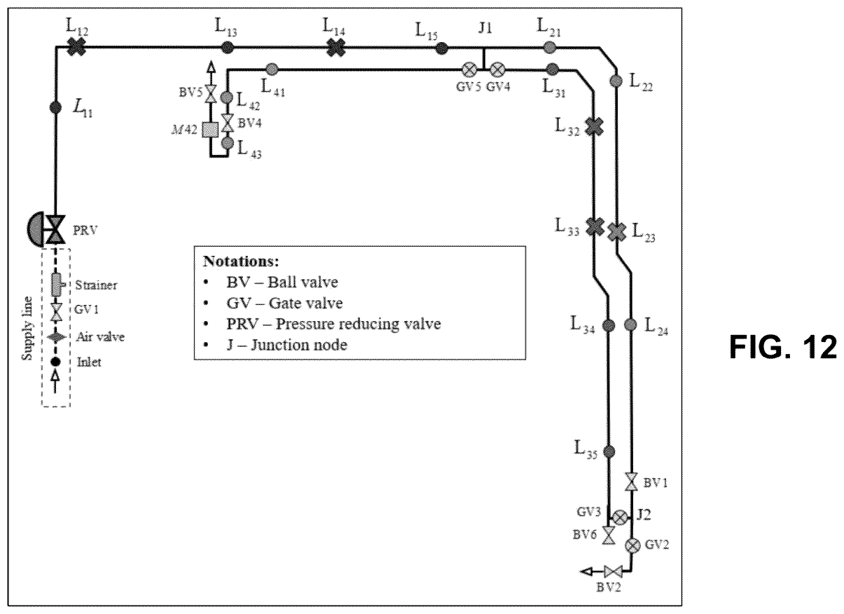

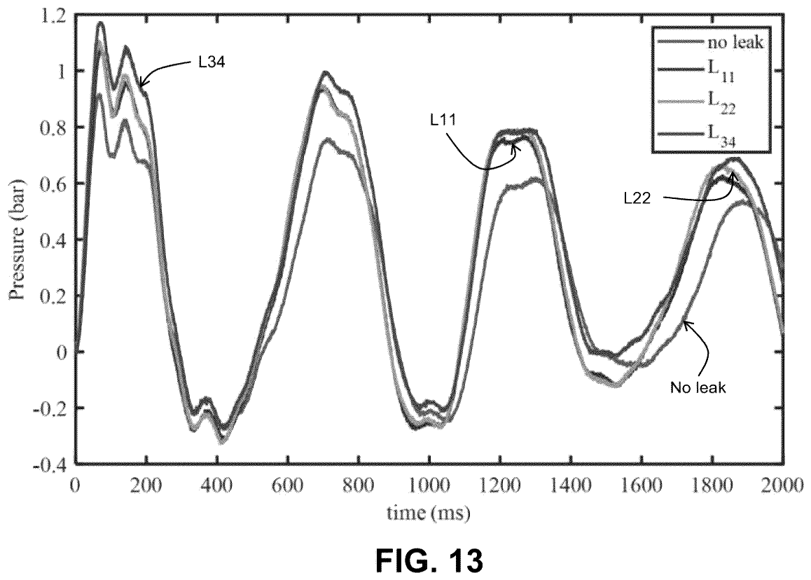

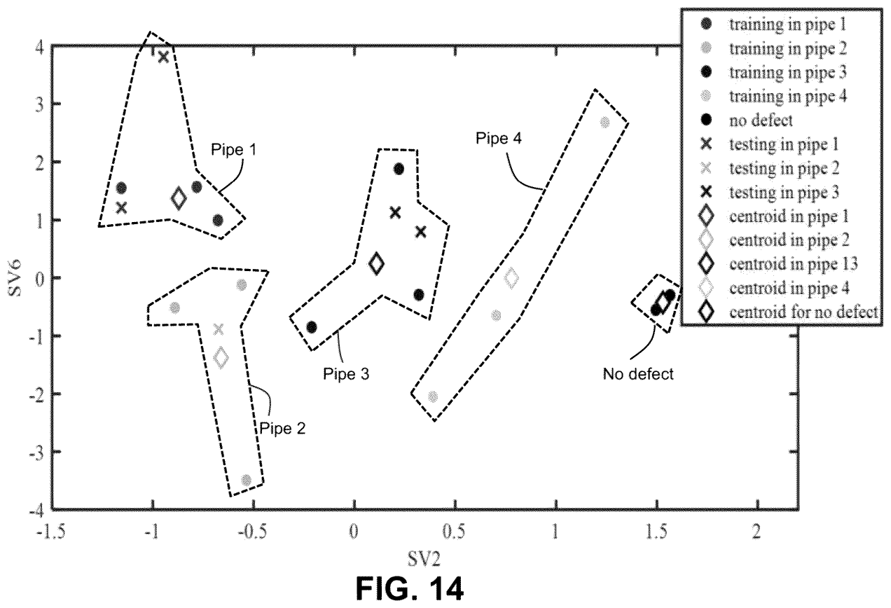

The disclosed technique was tested experimentally in a field-scale facility located at the Beacon Hill Intermediate Level Freshwater Service Reservoir, Kowloon, HK. The facility comprises four HDPE pipelines of 150 mm diameter (NS180) branched together via a junction (See FIG. 12). An upstream PRV regulates the incoming hydraulic pressure head from 0.5 to 6 bars. The first pipeline extends from the PRV to the branch junction and has a length of 65.6 m; pipelines 2, 3, and 4 extend from the junction to downstream valves and their lengths are, respectively, 79.23 m, 72.43 m, and 52.61 m. The demand flow is about 9 Ls⁻¹, and the simulated leak flow is about 3 Ls⁻¹. The training and test leak locations in each pipe are summarized in Table 12. The transient is generated by closing the downstream ball valve of pipeline 4 (BV5). An example of collected transient pressure signals is given in FIG. 13. In total, the training data set consists of 3×4=12 leak cases. The index vector is given by: I_{D}=[0, 1, 1, 1, 2, 2, 2, 3, 3, 3, 4, 4, 4]. The test data set includes 5 leak cases with index I_{T}=[1, 1, 2, 3, 3]. The outcome results of the disclosed technique after using Algorithms 1 and 2 are given in Table 13, and the corresponding graphical representation of the data projection is shown in FIG. 14. The prediction is 100% accurate. Nevertheless, it is important to note that the outcome of Algorithm 2 depends on the best SVs chosen. The prediction outcome can be different if a different SV space was used. Generally, accurate SV space is obtained when further training data is used and/or by increasing the cross-validation trials (i.e. input N_{CV} is Algorithm 1).

TABLE 12
Summary of leak locations for training and test data sets (BH experiment).

| Pipe | Pipe | Training leak | | | | | Testing leak | | |
|---|---|---|---|---|---|---|---|---|---|
| ID | length (m) | location (m) | | | | | location (m) | | |
| 1 | 65.6 | 8.91 | (L₁₁) | 38.02 | (L₁₃) | 62.07 (L₁₅) | 25.3 | (L₁₂) | 50.53 (L14) |
| 2 | 79.23 | 9.45 | (L₂₁) | 20.98 | (L₂₂) | 52.16 (L₂₄) | 37.6 (L₂₃) | | |
| 3 | 72.43 | 10.67 | (L₃₁) | 51.18 | (L₃₄) | 68.06 (L₃₅) | 21.87 | (L₃₂) | 36.64 (L₃₃) |

| | | | | | | |
|---|---|---|---|---|---|---|
| 4 | 52.61 | 26.24 | (L₄₁) | 34.6 | (L₄₂) | 42.13 (L₄₃) |

TABLE 13
Outcome of Algorithm 2: leaking-type defective
pipe index for BH experiment.

| | | | | | |
|---|---|---|---|---|---|
| True defective pipe index | 1 | 1 | 2 | 3 | 3 |
| Predicted defective pipe index | 1 | 1 | 2 | 3 | 3 |

### C. DETAILS OF EMBODIMENTS OF DISCLOSED METHOD

An aspect of the present disclosure is to provide a method for determining a state of health of a pressurized pipe network to thereby detect, classify or locate a possible defect occurred in the pipe network. Embodiments of the disclosed method are developed based on the methodology, applications and illustrative examples regarding the technique for defect detection, classification and location identification as disclosed above. Although the disclosed method is particularly useful to the case that the pressurized pipe network carries water as in a municipal water-supply system, the determination of the state of health of the pipe network as provided by the disclosed method is also applicable to other types of liquid.

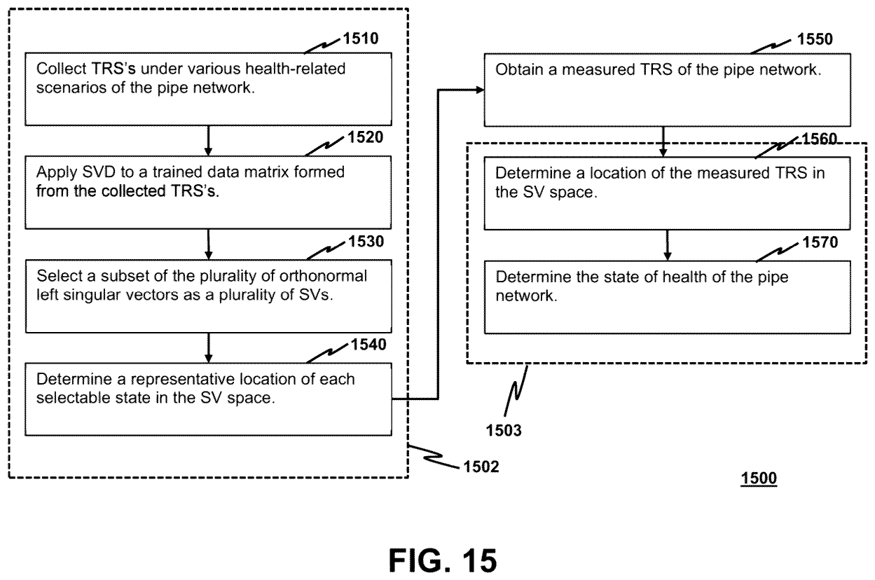

The disclosed method is illustrated with the aid of FIG. 15, which depicts a flowchart showing exemplary steps of the disclosed method (referenced as 1500). The method 1500 is a supervised ML method. As such, the method 1500 includes a training step 1502 and an inference step 1503. The training step 1502 includes steps 1510, 1520, 1530 and 1540. The inference step 1503 includes steps 1560 and 1570.

As mentioned above, the method 1500 is used for determining the state of health of the pressurized pipe system, and the determined state of health is used for detecting, classifying or locating the possible defect. Detection, classification or location identification of the possible defect is achievable by confining the state of health to be selected from a plurality of selectable states where respective selectable states are candidate answers to the problem of detecting, classifying or locating the possible defect. The plurality of selectable states is visualized as different values of the defective pipe index, intact case index, defect type index and defect location index (as shown in Section A.6). For illustration, an example of the plurality of selectable states is a set A given by A={no defect in the pipe network; defect in pipe section 1; defect in pipe section 2; leakage in pipe section 1; leakage in pipe section 2; blockage in pipe section 1; blockage in pipe section 2; defect at location 1 in a certain identified pipe section; defect at location 2 in a certain identified pipe section}.

In the step 1510, a plurality of TRSs obtained under a plurality of health-related scenarios of the pipe network, respectively, is collected. As used herein, “collecting a plurality of TRSs obtained under a plurality of health-related scenarios of the pipe network, respectively” is interpreted as collecting the plurality of TRSs such that an individual TRS in the plurality of TRSs is obtained under a corresponding health-related scenario associated with the individual TRS. The collected plurality of TRSs forms a training data set to be used in the training step 1502. Furthermore, an individual health-related scenario in the plurality of health-related scenarios is an instance of a corresponding selectable state in the plurality of selectable states. As used herein, “an individual health-related scenario being an instance of a corresponding selectable state” is interpreted as the individual health-related scenario being a certain scenario such that occurrence of this certain scenario in the pipe network results in the corresponding selectable state to become the state of health of the pipe network. As an illustrative example, scenarios in a set B as follows are instances of a selectable state of “leakage in pipe section 1”: B={leak at 1st location in pipe section 1; leak at 2nd location in pipe section 1; leak at 3rd location in pipe section 1}.

Usually, the plurality of selectable states includes a plurality of defective states, thereby allowing the possible defect to be classified. For example, the plurality of defective states in the set A is a set A₂ given by A₂={defect in pipe section 1; defect in pipe section 2; leakage in pipe section 1; leakage in pipe section 2; blockage in pipe section 1; blockage in pipe section 2; defect at location 1 in a certain identified pipe section; defect at location 2 in a certain identified pipe section}. In the presence of the plurality of defective states, the plurality of health-related scenarios includes a plurality of defect scenarios. For illustration, each of the scenarios in the set B is a defect scenario.

In certain embodiments, the plurality of defective states includes one or more first defective states each related to a leakage defect in the pipe network. For example, defective states “leakage in pipe section 1” and “leakage in pipe section 2” in A₂ are deemed to be two first defective states.

In certain embodiments, the plurality of defective states includes one or more second defective states each related to a blockage defect in the pipe network. For example, defective states “blockage in pipe section 1” and “blockage in pipe section 2” in A₂ are deemed to be two second defective states.

In addition to the plurality of defective states, the plurality of selectable states may further include a no-defect state, thereby additionally allowing the possible defect to be detected. The plurality of health-related scenarios further includes an intact case.

Respective TRS's in the plurality of TRSs may be time response signals or frequency response signals. Note that the respective TRSs are responses due to excitation signals that have same signal waveform and same power and that are applied to same location in the pipe network. If the respective TRSs are time response signals, the excitation signals are usually selected to be short acoustic pulses of high power. If, alternatively, the respective TRSs are frequency response signals, one may select continuous acoustic signals each having frequency components over a wideband.

The plurality of TRSs may be experimentally obtained or may be obtained through computer simulation. In one embodiment, the step 1510 comprises obtaining a corresponding TRS under the individual health-related scenario by computer simulation according to a calibrated model of the pipe network, whereby the plurality of TRSs is obtained. For instance, the numerical model based on the MOC as used in Section B.1 may be used to simulate different scenarios for obtaining corresponding TRSs. Alternatively, in another embodiment, the step 1510 comprises experimentally measuring the plurality of TRSs under the plurality of health-related scenarios, respectively. As an example, Section 6.B describes a procedure of experimentally simulating leaks in a real-life pipe network and physically generating a transient in the pipe network.

In practice, there is often a time gap (which may be days, months or even years) between determining the state of health of the pipe network in the inference step 1503 and doing measurements or simulations to obtain the plurality of TRS's in the training step 1502. In certain embodiments of the step 1510, the collected plurality of TRS's is retrieved from a database that stores a copy of the plurality of TRS's obtained experimentally or by simulation.

After the plurality of TRSs is collected in the step 1510, SVD is applied to a trained data matrix in the step 1520, where the trained data matrix is formed by allocating respective TRSs in the plurality of TRSs to either different rows or different columns of the trained data matrix. The SVD of the trained data matrix yields a plurality of singular values, a plurality of orthonormal left SVs and a plurality of orthonormal right SVs. An individual singular value is associated with corresponding left and right SVs. In addition, respective left SVs in the plurality of orthonormal left SVs are mutually orthonormal. Similarly, respective right SVs in the plurality of orthonormal right SVs are also mutually orthonormal.

Note that in Section A, the trained data matrix M_{D} is constructed by row-wise allocation of respective TRSs into M_{D} as shown in EQN. (1), and the SVD of M_{D} is given by EQN. (4). Those skilled in the art will appreciate that adapting the procedure given in Section A to another trained data matrix constructed by column-wise allocation of the respective TRSs is reasonably easy.

In the step 1530, a subset of the plurality of orthonormal left SVs is selected as a plurality of selected SVs such that a least error is obtained in predicting a scenario randomly selected from the plurality of health-related scenarios via projecting a corresponding TRS of the selected scenario onto a SV space spanned by the selected subset.

As mentioned in Section A.3, projecting TRS onto 2D or 3D SV space is usually sufficient to classify the possible defect. Preferably, the plurality of selected SVs as determined in the step 1530 consists of a first predetermined number of SVs, where the first predetermined number is 2 or 3.

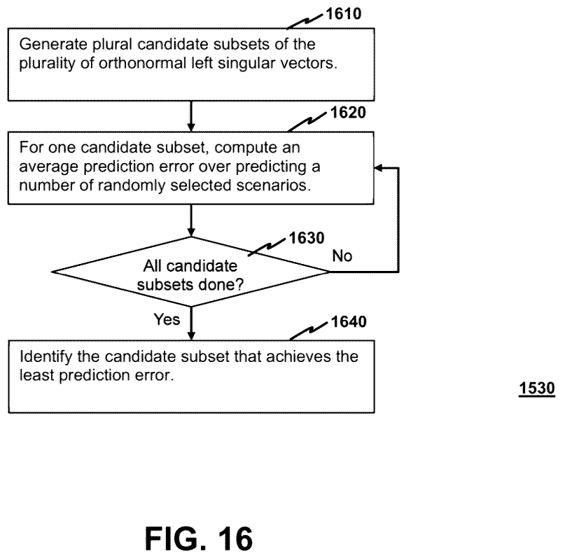

FIG. 16 depicts a workflow showing constituent steps of the step 1530 in accordance with certain embodiments of the present disclosure. The workflow is developed based on the methodology illustrated in Section A.4. The step 1530 includes steps 1610, 1620, 1630 and 1640. In the step 1610, plural candidate subsets of the plurality of orthonormal left SVs are generated. For each of the candidate subsets, an average prediction error over predicting a second predetermined number of scenarios randomly selected from the plurality of health-related scenarios is computed in the step 1620. The step 1630 repeats the step 1620 for different candidate subsets until all the candidate subsets are processed. At the completion of the step 1630, a plurality of average prediction errors generated for the candidate subsets is obtained. Based on the plurality of average prediction errors, a certain candidate subset that achieves the least prediction error over respective average prediction errors obtained for the candidate subsets is identified in the step 1640.

In certain embodiments, the second predetermined number is selected to be half of a total number of scenarios in the plurality of health-related scenarios.

In a first embodiment of the step 1610, the candidate subsets are generated as all possible combinations of the first predetermined number of vectors selected from the plurality of orthonormal left SVs. As mentioned above, the first predetermined number is either 2 or 3. In a second embodiment thereof, the candidate subsets are generated as all possible combinations of 2 to 3 vectors selected from the plurality of orthonormal left SVs. Note that in the aforementioned first and second embodiments of the step 1610, exhaustive search is carried out in identifying the plurality of selected SVs.

After the plurality of selected SVs is determined in the step 1530, a representative location of an individual selectable state in the SV space is determined in the step 1540 according to a cluster of locations of one or more first TRSs projected onto the SV space. An individual first TRS is in the training data set, and a corresponding health-related scenario under which the individual first TRS is obtained is an instance of the individual selectable state. As a result, plural representative locations of respective selectable states are obtained.

Preferably, as used in the step 5 the disclosed technique, the representative location of the individual selectable state is determined as a centroid of the cluster of locations of the one or more first TRSs in the SV space.

After the training step 1502 is completed, the inference step 1503 can be executed to infer the state of health of the pipe system by utilizing the plurality of selected SVs and the representative locations of the respective selectable states.

The disclosed method 1500 further includes a step 1550 of obtaining a measured TRS of the pipe network. The inference step 1503 infers the state of health according to the measured TRS. The measured TRS is experimentally obtained. Note that in practice, the plurality of TRSs collected in the training step 1502 is obtained earlier than obtaining the measured TRS.

After the measured TRS is obtained, a location of the measured TRS in the SV space is determined in the step 1560. Since the plurality of selected SVs consists of vectors that are mutually orthonormal, the location of the measured TRS in the SV space can be conveniently found by computing dot products each between the measured TRS and an individual vector in the plurality of selected SVs. The dot products as computed collectively form a coordinate regarded as the location of the measured TRS in the SV space.

In the step 1570, the state of health is determined as a first selectable state in the plurality of selectable states such that the location of the measured TRS in the SV space is closest to the representative location of the first selectable state among respective selectable states in the plurality of selectable states. That is, a minimum-distance strategy as elaborated in Section A.5 is employed in the step 1570 to determine the state of health.

The present disclosure may be embodied in other specific forms without departing from the spirit or essential characteristics thereof. The present embodiment is therefore to be considered in all respects as illustrative and not restrictive. The scope of the invention is indicated by the appended claims rather than by the foregoing description, and all changes that come within the meaning and range of equivalency of the claims are therefore intended to be embraced therein.

### REFERENCES

There follows a list of references that are occasionally cited in the specification. Each of the disclosures of these references is incorporated by reference herein in its entirety.
Asghari, V., Kazemi, M. H., Duan, H. F., Hsu, S. C., & Keramat, A. (2023). Machine learning modeling for spectral transient-based leak detection. Automation in Construction, 146, 104686.
Ayati, A. H., Haghighi, A., & Ghafouri, H. R. (2022). Machine Learning-Assisted Model for Leak Detection in Water Distribution Networks Using Hydraulic Transient Flows. Journal of Water Resources Planning and Management, 148(2), 04021104.
Beucler, T., Pritchard, M., Rasp, S., Ott, J., Baldi, P., and Gentine, P. (2021). “Enforcing analytic constraints in neural networks emulating physical systems.” Physical Review Letters, 126(9), 098302.
Bohorquez Arevalo, J., Lambert, M. F., Alexander, B., Simpson, A. R., & Abbott, D. (2022). Stochastic Resonance Enhancement for Leak Detection in Pipelines Using Fluid Transients and Convolutional Neural Networks. American Society of Civil Engineers.

Bohorquez, J., Alexander, B., Simpson, A. R., and Lambert, M. F. (2020). “Leak detection and topology identification in pipelines using fluid transients and artificial neural networks.” Journal of Water Resources Planning and Management, 146(6), 04020040.
Bond, A., Mergelas, B., and Jones, C. (2004). “Pinpointing leaks in water transmission mains.” Pipeline Engineering and Construction: What's on the Horizon?, 1-10.
Brunone, B. (1999). “Transient test-based technique for leak detection in outfall pipes.” Journal of water resources planning and management, 125(5), 302-306.
Brunone, B., Meniconi, S., and Capponi, C. (2018). “Numerical analysis of the transient pressure damping in a single polymeric pipe with a leak.” Urban Water Journal, 15(8), 760-768.
Brunton, S. L. and Kutz, J. N. (2019). Data-driven science and engineering: Machine learning, dynamical systems, and control. Cambridge University Press.
Capponi, C., Ferrante, M., Zecchin, A. C., and Gong, J. (2017). “Leak detection in a branched system by inverse transient analysis with the admittance matrix method.” Water Resources Management, 31(13), 4075-4089.
Connor, R. (2015). The United Nations world water development report 2015: water for a sustainable world, Vol. 1. UNESCO publishing.
Covas, D., Ramos, H., and De Almeida, A. B. (2005). “Standing wave difference method for leak detection in pipeline systems.” Journal of Hydraulic Engineering, 131(12), 1106-1116.
Covas, D., Ramos, H., Graham, N., and Maksimovic, C. (2004). “Application of hydraulic transients for leak detection in water supply systems.” Water Science and Technology: Water Supply, 4(5-6), 365-374.
District Council, H. K. (2020). “Anderson road quarry joint cavern development (9). Online, accessed 3 Nov. 2021.
Duan, H.-F., Lee, P. J., Ghidaoui, M. S., and Tung, Y.-K. (2012). “System response function-based leak detection in viscoelastic pipelines.” Journal of Hydraulic Engineering, 138(2), 143-153.
Dubey, A., Li, Z., Lee, P., and Murch, R. (2019). “Measurement and characterization of acoustic noise in water pipeline channels.” IEEE Access, 7, 56890-56903.
Eng, L. S. P. and Eng, T. R. P. (2013). “Development of a long duration, free swimming, inline acoustic leak detection inspection tool.
Ferrante, M., Brunone, B., and Meniconi, S. (2007). “Wavelets for the analysis of transient pressure signals for leak detection.” Journal of Hydraulic Engineering, 133(11), 1274-1282.
Kapelan, Z. S., Savic, D. A., and Walters, G. A. (2003). “A hybrid inverse transient model for leakage detection and roughness calibration in pipe networks.” Journal of Hydraulic Research, 41(5), 481-492.
Lee, P. J., Vítkovsky, J. P., Lambert, M. F., Simpson, A. R., and Liggett, J. A. (2005). “Frequency domain analysis for detecting pipeline leaks.” Journal of Hydraulic Engineering, 131(7), 596-604.
Liao, Z., Yan, H., Tang, Z., Chu, X., and Tao, T. (2021). “Deep learning identifies leak in water pipeline system using transient frequency response.” Process Safety and Environmental Protection, 155, 355-365.
Liggett, J. A. and Chen, L.-C. (1994). “Inverse transient analysis in pipe networks.” Journal of Hydraulic Engineering, 120(8), 934-955.
Louati, M., Ghidaoui, M. S., Tekitek, M. M., and Jose Lee, P. (2020). “Wave-leak interaction in a simple pipe system.” Journal of Hydraulic Engineering, 146(4), 04020013.
Mpesha, W., Hanif Chaudhry, M., and Gassman, S. L. (2002). “Leak detection in pipes by frequency response method using a step excitation.” Journal of hydraulic research, 40(1), 55-62.
Meniconi, S., Cifrodelli, M., Capponi, C., Duan, H. F., & Brunone, B. (2021). Transient response analysis of branched pipe systems toward a reliable skeletonization. Journal of Water Resources Planning and Management, 147(2), 04020109.
Nixon, W. and Ghidaoui, M. S. (2007). “Numerical sensitivity study of unsteady friction in simple systems with external flows.” Journal of Hydraulic Engineering, 133(7), 736-749.
Rumelhart, D. E., Widrow, B., and Lehr, M. A. (1994). “The basic ideas in neural networks.” Communications of the ACM, 37(3), 87-93.
Sattar, A. M. and Chaudhry, M. H. (2008). “Leak detection in pipelines by frequency response method.” Journal of Hydraulic Research, 46(sup1), 138-151.
Vítkovsky, J. P., Lambert, M. F., Simpson, A. R., and Liggett, J. A. (2007). “Experimental observation and analysis of inverse transients for pipeline leak detection.” Journal of Water Resources Planning and Management, 133(6), 519-530.
Wang, X. and Ghidaoui, M. S. (2018). “Pipeline leak detection using the matched-field processing method.” Journal of Hydraulic Engineering, 144(6), 04018030.
Wang, X.-J., Lambert, M. F., Simpson, A. R., Liggett, J. A., and Vítkovsky, J. P. (2002). “Leak detection in pipelines using the damping of fluid transients.” Journal of Hydraulic Engineering, 128(7), 697-711.
Waqar, M., Louati, M., and Ghidaoui, M. S. (2019). “Leak localization using time reversal technique.” In Proceedings of the 38th IAHR World Congress, Panama City, Panama, Vol. 10.
Waqar, M., Louati, M., and Ghidaoui, M. S. (2022). “Time-reversal of water-hammer waves.” Journal of Hydraulic Research, 60(1), pp 25-45.
Yacouby, R., & Axman, D. (2020 November). Probabilistic extension of precision, recall, and f1 score for more thorough evaluation of classification models. In Proceedings of the first workshop on evaluation and comparison of NLP systems (pp. 79-91).
Zhou, B., Lau, V., and Wang, X. (2019). “Machine-learning-based leakage-event identification for smart water supply systems.” IEEE Internet of Things Journal, 7(3), 2277-2292.
Zouari. F., Blåsten. E., Louati. M., and Ghidaoui, M. S. (2019). “Internal pipe area reconstruction as a tool for blockage detection.” Journal of Hydraulic Engineering. 145(6). 04019019.

What is claimed is:

1. A method for determining a state of health of a pressurized pipe network to thereby detect, classify or locate a possible defect occurred in the pipe network, the state of health being selected from a plurality of selectable states, the method comprising:
collecting a plurality of transient response signals (TRSs) obtained under a plurality of health-related scenarios of the pipe network, respectively, to form a training data set, wherein an individual health-related scenario is an instance of a corresponding selectable state;
applying singular value decomposition (SVD) to a trained data matrix to identify a plurality of orthonormal left singular vectors (SVs) of the trained data matrix, wherein the trained data matrix is formed by allocating respective TRSs in the plurality of TRSs to either different rows or different columns of the trained data matrix;
selecting a subset of the plurality of orthonormal left SVs as a plurality of selected SVs such that a least error is obtained in predicting a scenario randomly selected from the plurality of health-related scenarios via projecting a corresponding TRS of the selected scenario onto a SV space spanned by the selected subset;
determining a representative location of an individual selectable state in the SV space according to a cluster of locations of one or more first TRSs projected onto the SV space, wherein an individual first TRS is in the training data set, and a corresponding health-related scenario under which the individual first TRS is obtained is an instance of the individual selectable state;
obtaining a measured TRS of the pipe network;
determining a location of the measured TRS in the SV space; and
determining the state of health as a first selectable state in the plurality of selectable states such that the location of the measured TRS in the SV space is closest to the representative location of the first selectable state among respective selectable states in the plurality of selectable states.

2. The method of claim 1, wherein:
the plurality of selectable states includes a plurality of defective states, thereby allowing the possible defect to be classified; and
the plurality of health-related scenarios includes a plurality of defect scenarios.

3. The method of claim 2, wherein the plurality of defective states includes one or more first defective states each related to a leakage defect in the pipe network.

4. The method of claim 2, wherein the plurality of defective states includes one or more second defective states each related to a blockage defect in the pipe network.

5. The method of claim 2, wherein:
the plurality of selectable states further includes a no-defect state, thereby additionally allowing the possible defect to be detected; and
the plurality of health-related scenarios further includes an intact case.

6. The method of claim 2, wherein the plurality of defective states includes plural third defective states related to presence of the possible defect at different locations, respectively, thereby additionally allowing the possible defect to be located.

7. The method of claim 1, wherein the plurality of selected SVs consists of a first predetermined number of SVs, the first predetermined number being 2 or 3.

8. The method of claim 1, wherein the selecting of the subset of the plurality of orthonormal left SVs as the plurality of selected SVs comprises:
generating plural candidate subsets of the plurality of orthonormal left SVs; and
for each of the candidate subsets, computing an average prediction error over predicting a second predetermined number of scenarios randomly selected from the plurality of health-related scenarios, whereby the least error is identified from respective average prediction errors obtained for the candidate subsets.

9. The method of claim 8, wherein the second predetermined number is selected to be half of a total number of scenarios in the plurality of health-related scenarios.

10. The method of claim 8, wherein the candidate subsets are generated as all possible combinations of a first predetermined number of vectors selected from the plurality of orthonormal left SVs, the first predetermined number being either 2 or 3.

11. The method of claim 8, wherein the candidate subsets are generated as all possible combinations of 2 to 3 vectors selected from the plurality of orthonormal left SVs.

12. The method of claim 1, wherein the representative location of the individual selectable state is determined as a centroid of the cluster of locations of the one or more first TRSs in the SV space.

13. The method of claim 1, wherein an individual TRS in the plurality of TRSs is a time response signal.

14. The method of claim 1, wherein an individual TRS in the plurality of TRSs is a frequency response signal.

15. The method of claim 1, wherein the collecting of the plurality of TRSs comprises obtaining a corresponding TRS under the individual health-related scenario by computer simulation according to a calibrated model of the pipe network, whereby the plurality of TRSs is obtained.

16. The method of claim 1, wherein the collecting of the plurality of TRSs comprises experimentally measuring the plurality of TRSs under the plurality of health-related scenarios, respectively.

17. The method of claim 1, wherein the collected plurality of TRSs is retrieved from a database that stores a copy of the plurality of TRSs obtained experimentally or by numerical simulation.
